(19) United States
(12) Patent Application Publication
(10) Pub. No.: US 2004/0030687 A1
(43) Pub. Date: Feb. 12, 2004

(54) Information collection system and method

(75) Inventors: Yufuko Hidaka, Sagamihara-shi (JP); Saeko Murakami, Yokohama-shi (JP); Hirobumi Toyoshima, Tokyo (JP); Hajime Tsuchitani, Kamakura-shi (JP)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/622,526

(22) Filed: Jul. 18, 2003

(30) Foreign Application Priority Data
Jul. 26, 2002 (JP) 2002-218740

(51) Int. Cl. G06F 17/30; G06F 7/00

(52) U.S. Cl. 707/3

(57) ABSTRACT

A user registers interests in order to obtain data relative to those interests. A plurality of web sites are searched based on the user's interests. An extraction rule mechanism is applied to HTML documents acquired. A vocabulary information processing mechanism reads an ontology based on information received to obtain vocabulary information. An inference processing mechanism executes an inference operation based on axiom rules. An extracting position information identifying section extracts data objects relying on HTML document tags with respect to the acquired HTML documents, based on the extraction rules, the vocabulary information processing mechanism, and the inference processing mechanism.

### FIELD OF THE INVENTION

The present invention relates to a system for collecting/pigeonholing information, and more specifically, to a collection system that, for example, sums up similar items with respect to catalog information of various domains published on the Web, based on prescribed extraction rules, and displays them.

### BACKGROUND OF THE INVENTION

Since the spread of utilization of the Internet, a user receives distribution of Web contents via the Web (World Wide Web: WWW) from various sites for information about, for example, cars, personal computers (PCs), real estate or financial information. The user acquires catalog information, etc. from home pages of car companies, computer companies or the like, and compares and reviews the information in order to assist with the buying of a commodity.

Such catalog information is frequently offered in a table format wherein various information classified per item, and thus seemingly designed to be an easy-to-see user format. However, such information is prepared with a unique standard by each company making it difficult for the user to compare and review the information. For example, in PC catalogs, “CPU” is used by company A while “processor” is used by company B, so that different expressions are used for the same thing. Further, in descriptions of notebook PCs, for example, company A uses “battery weight” and “body weight” while company B uses a “total weight,” so that different expressions are used.

A user may open sites one by one and compare them on a manual basis. Furthermore, there are cases in which data is extracted about respective cars from published information (catalogs, releases, etc.), and offered for sale to users. However, since the foregoing types of operations are performed on a manual basis, they are time consuming to create and use, accurate results cannot be assured. Further, when comparison results are prepared using the same terms and definitions, updating may be implemented on a manual basis making it difficult to offer timely information to users. Additionally, updating is frequently delayed, so users are unavoidably required to implement the final confirmation of up-to-date information using home pages, catalogs, etc. of the respective makers.

In view of this, it is desirable to mechanically extract a plurality of information pieces on the Internet. However, Web pages are presently described only in an HTML format, and described tables only take into account ease of use for users, resulting in complicated table structure with a complicated tree structure. Thus, necessary information can not be extracted easily. It can be said that such information is a document that is not structured from a mechanical point of view. Accordingly, for example, it is difficult to mechanically judge where information exists on a page, and further, since the same concept is expressed by different wording, it is difficult to mechanically perform secondary processing after a user has obtained information.

Further, for example, there are available sites that offer aggregate information of various data, which is obtained on a so-called Screen Scraping method (method of acquiring necessary information by programming based on built-up HTML structures of respective companies). Accordingly, if the HTML structure of the information offering site changes, information collection can not be carried out. Therefore, most information is manually input into their own databases.

Further, software tools are available that check television programs without failure. In this software tool, a user can define synonyms, and information about television programs is acquired from Web pages of TV guides of respective companies and extracted based on a user's interest. However, in such a software tool, definition files are provided for the respective companies and information is extracted using those files. Therefore, it cannot be used without preparing the definition files for the respective companies to a sufficient level, and thus lacks in flexibility.

Further, presently, there are available those Web clipping services that can acquire information from desired Web site positions based on designation by a user. Specifically, paying attention to a DOM (Document Object Model) structure of a page and utilizing Xpath, a designated position can be automatically clipped upon every designated time period or upon every occurrence of change. However, if the whole page structure or layout changes, the DOM structure also changes so that it becomes difficult to automatically perform clipping.

The present invention has been made for solving the foregoing technical problems and has an object to automatically extract, for example, catalogs and so forth of various domains published on the Web.

Another object of the present invention is to sum up the extracted same items into, for example, one table and offer it to a user.

Still another object of the present invention is to cope with the summing-up over domains of a wide range.

### SUMMARY OF THE INVENTION

Documents (data files) not structured for a computer to interpret are analyzed using an ontology defining relationships between vocabularies. Useful information is automatically extracted from existing catalogs etc. of respective companies that are individually present on the Web, and information having the same meaning are summed up to offer information that is useful, such as a comparison table, to a user. Specifically, an information collection system according to the present invention comprises means for acquiring a plurality of nonstructural data files via a network; analyzing means for conducting an analysis with respect to the plurality of data files acquired by the means for acquiring, using a prescribed extraction rule and an ontology being relational description of terms; and extracting means for extracting necessary information from the plurality of data files based on the analysis by the analyzing means.

Here, the data files acquired by the means for acquiring include so-called nonstructural text, sounds, pictures, etc. that cannot be read by a machine (computer) and applied with secondary processing as they are. Particularly, the means for acquiring documents described in HTML (Hypertext Markup Language) using URLs (Uniform Resource Locators) based on a user's interest, and the analyzing means analyzes the documents using specific tag information. As this specific tag information, HTML table tags or list tags may be cited. With respect to the extraction rule and the ontology, suitable ones can be selected according to a user's input. In this event, other than a case where ontology identifying data and extraction rule identifying data are included in input data from a user, there is also a case where an extraction rule or an ontology is selected based on input data representing some user's interest.

The prescribed extraction rule is used in the analysis features catalog and/or specification information put into a rule. The analyzing means analyzes content transversely using the ontology with respect to the plurality of data files using different terms. The information collection system further comprises offering means for reconstructing the information extracted, aggregating equivalent relationships from the information, and offering them to a user terminal.

The information collection system further comprises means for storing ontologies that differ per object, wherein the analyzing means conducts an analysis by reading a prescribed ontology from the ontology means for storing. This arrangement can cope with information collection and analysis in various fields without a significant change to a program.

An application server in accordance with the present invention comprises a section for receiving information about a user's interest; a section for acquiring HTML documents from a plurality of sites based on the information received from the request receiving section; a vocabulary information processing mechanism for reading an ontology based on the information received from the user request receiving section to acquire vocabulary information; and an information identifying section for extracting data objects with respect to the HTML documents acquired from the HTML acquiring section, relying on tags of the HTML documents and based on the vocabulary information offered from the vocabulary information processing mechanism.

An extraction rule processing mechanism offers an extraction rule for applying extraction processing to the HTML documents acquired from the HTML acquiring section, and an inference processing mechanism for executing an inference operation based on an axiom rule, wherein the extracting position information identifying section extracts the extraction data objects based on the extraction rule offered from the extraction rule processing mechanism and based on the inference operation executed by the inference processing mechanism.

The application server further comprises an information arranging/aggregating section for applying a summing process to the plurality of extraction data objects extracted by the extracting position information identifying section; a summing result object producing section for producing a table and/or a list based on a result of the summing process by the information arranging/aggregating section; and a user request transmitting section for transmitting a summing result object produced by the summing result object producing section. This arrangement is excellent in that the summing result can be offered to the user in a useful manner.

Further, an information collection method according to the present invention comprises, in a computer connected to a network, a step of acquiring a plurality of nonstructural data files (HTML documents) via the network; a step of extracting information from the HTML documents acquired via the network based on table tags or list tags; a step of analyzing the plurality of acquired and extracted data files using a prescribed extraction rule and an ontology being relational description of terms; a step of extracting useful information from the plurality of analyzed data files; and a step of reconstructing the extracted useful information in a manner useful to a user. Here, it may be arranged that the step of analyzing comprises a step of performing positioning of a table using the extraction rule that is obtained by putting features constituting catalog and/or specification information into a rule, and a step of smoothing a swing of vocabularies based on the ontology that defines vocabulary information representing whether or not a headline of the positioned table is a vocabulary that is generally used in a category designated by the user.

From another aspect, an information collection method according to the present invention comprises, in a computer connected to the Internet, a step of receiving information about a user's interest; a step of acquiring a plurality of documents via the Internet based on the user's interest; a step of selecting a specific ontology based on the user's interest from a plurality of stored ontologies; and a step of analyzing contents transversely with respect to the plurality of acquired documents using the selected specific ontology, thereby to extract useful information.

An information collection method according to the present invention comprises, in a computer connected to a network, acquiring a plurality of Web pages including information expressed by different vocabularies with respect to associated contents, respectively; extracting information from the plurality of acquired Web pages based on table tags or list tags; analyzing the extracted information transversely with respect to the different vocabularies of the plurality of Web pages based on an ontology representing relationships between vocabularies; summing up the analyzed information; and transmitting a summing result to a user terminal. Here, it may be arranged that the summing applies superordinate/subordinate conceptual processing and/or relational processing to the different vocabularies on the respective Web pages, thereby to implement matching of items.

Further, the present invention can be understood as a program that is executed by a computer functioning as a server connected to a network. This program causes a computer to have a function of acquiring a plurality of nonstructural data files via a network; a function of analyzing the plurality of acquired data files using a prescribed extraction rule, an ontology being relational description of terms, and an inference operation based on a prescribed axiom rule; a function of extracting useful information from the plurality of analyzed data files; and a function of reconstructing the extracted useful information in a manner useful to a user, for example, processing an equivalent relationship with respect to associated vocabulary and value to insert a new relationship, thereby to reconstruct the information.

Further, a program according to the present invention causes a computer to have a function of acquiring a plurality of documents via the Internet based on information about a user's interest; a function of selecting a specific ontology based on the user's interest from a plurality of stored ontologies; and a function of analyzing contents transversely with respect to the plurality of acquired documents using the selected specific ontology.

Further, a program according to the present invention causes a computer to have a function of acquiring a plurality of Web pages including information expressed by different vocabularies with respect to associated contents, respectively; a function of extracting information from the plurality of acquired Web pages based on table tags or list tags; a function of analyzing the extracted information transversely with respect to the different vocabularies of the plurality of Web pages based on an ontology representing relationships between vocabularies; and a function of summing up the analyzed information.

Each of those programs may be offered to a customer in the state wherein the program is installed in a computer such as a server when the computer is offered to the customer, or in the state wherein the program is stored in a storage medium in a computer-readable manner. The storage medium may be, for example, a floppy disk or CD-ROM, wherein the program is read by a floppy disk drive or CD-ROM drive and loaded-into a flash ROM or the like, thereby to be executed. On the other hand, the program may also be offered via a network by means of, for example, a program transmitter. This program transmitter, for example, may be provided in a server on the host side and include a memory for storing programs and program transmitting means for offering programs via the network.

### BRIEF DESCRIPTION OF THE DRAWINGS

Hereinbelow, the present invention will be described in detail based on a preferred embodiment shown in the accompanying drawings, in which:

FIG. 1 is a diagram showing the overall structure of an information collection system according to a preferred embodiment of the present invention;

FIG. 2 is a block diagram showing a functional structure of an information distribution system according to the preferred embodiment;

FIG. 3 is a flowchart showing the flow of the overall processing executed by the respective functions shown in the block diagram of FIG. 2;

FIG. 4 is a flowchart describing in further detail the processing in accordance with the preferred embodiment;

FIG. 5 is a flowchart describing the display to a user terminal;

FIG. 6 is a diagram showing one example of a catalog published on the Web;

FIG. 7 is a diagram showing another example of a catalog published on the Web; and

FIG. 8 is a diagram showing a summing-up display example in the preferred embodiment.

### DETAILED DESCRIPTION OF THE INVENTION

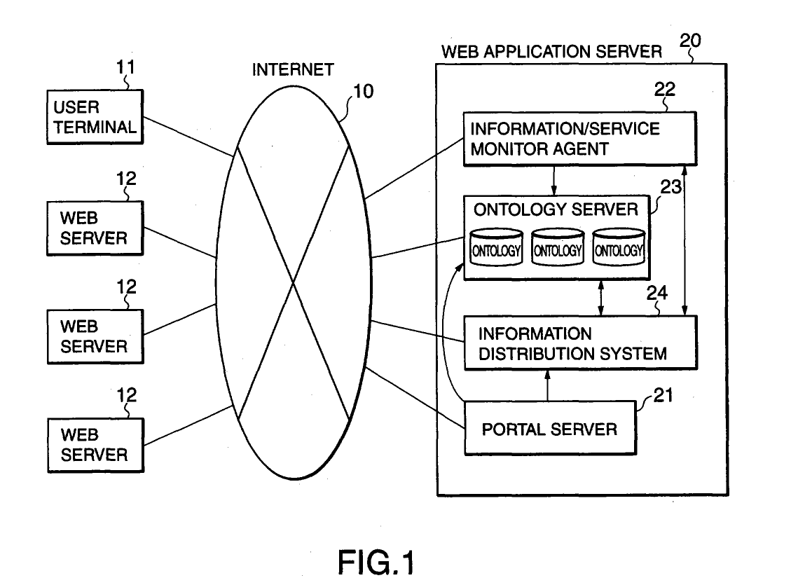

FIG. 1 is a diagram showing the overall structure of an information collection system in accordance with this embodiment. The information collection system shown in FIG. 1 comprises a user terminal 11 such as a PDA (Personal Digital Assistant) or a notebook PC that is connectable to a network, Web servers 12 for respective companies offering Web pages of various catalogs and information, and a Web application server 20 that offers an information collection service to the user terminal 11 connected to each other via the Internet 10. It is possible to take only the Web application server 20 as an information collection system in a narrow sense. As used herein, the word “system” includes functions in the same housing or connected via a prescribed network.

The Web application server 20 comprises a portal server 21 that receives registration of a user's interest from the user terminal 11 and offers a first access page relative to an information collection service, an information/service monitor agent 22 that collects information from the Web servers 12 of the respective companies via the Internet 10, an ontology server 23 that stores ontologies representing relationships among vocabularies in databases and offers vocabulary information groups, and an information distribution system 24 that executes information collection processing based on a user's request obtained via the portal server 21 and offers the result thereof to the user terminal 11. The information distribution system 24 checks whether or not an interest registered by the user from the user terminal 11 and collected information agree with each other. The ontology server 23 stores ontologies (e.g. notebook pc ontology, digital camera ontology, real estate ontology) that differ per object in respective databases, and functions to switch the ontology per object. When a user's interest, for example, “If there is information that a stock price of company A exceeds 100, please notify” is registered, the information distribution system 24 checks information collected by the information/service monitor agent 22 and, when there is information agreeing with the interest, returns a result that there is agreement.

Hereinbelow, for facilitating understanding, an outline of the information collection processing in this embodiment will be explained. In general, information described in HTML from the Internet 10, aims at a visual expression relative to the user, and can be said to be a nonstructural data file relative to a computer. Therefore, much time and labor are required for comparing (collecting/pigeonholing) information on the Internet 10. Specifically, the information described in HTML does not have a format that can easily deal with a data structure, and, therefore, it is difficult to mechanically judge where information exists on each page, and it is difficult to mechanically perform secondary processing to extract the information. Further, the same concept is frequently expressed differently, so that it is difficult to mechanically extract useful information for a user. In this embodiment, pamphlets/catalogs of various domains published on the Web are electronically distributed, the distributed pamphlets/catalogs are automatically extracted, and the same items are summed up into one table, thereby facilitating comparison by a user. Further, in this embodiment, the summing-up over wide-range domains can be achieved by switching extraction rules, vocabularies and concept schemes (ontologies) with respect to tables described in catalogs, etc. of the respective domains.

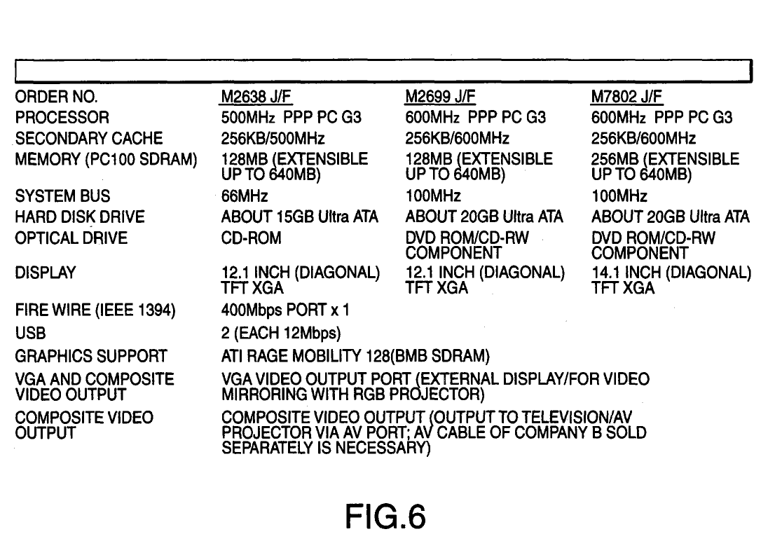

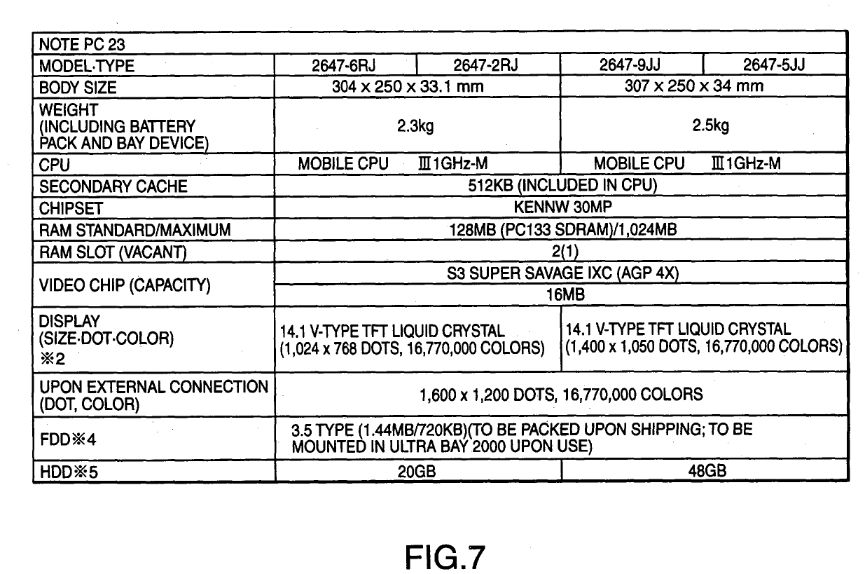

FIGS. 6 and 7 each show one example of a catalog published on the Web. Here, examples of Web pages offered from the respective Web servers 12 of PC makers are shown. In the catalog shown in FIG. 6, a CPU that executes input/output, commands, and etc. of a computer is called “processor”, and a specification of this “processor” is indicated per type thereof. On the other hand, in the catalog shown in FIG. 7, this is called “CPU”, and a specification thereof is indicated per type. Conventionally, it has been necessary for a user to view and manually compare these catalogs in order to make a decision for purchasing or the like.

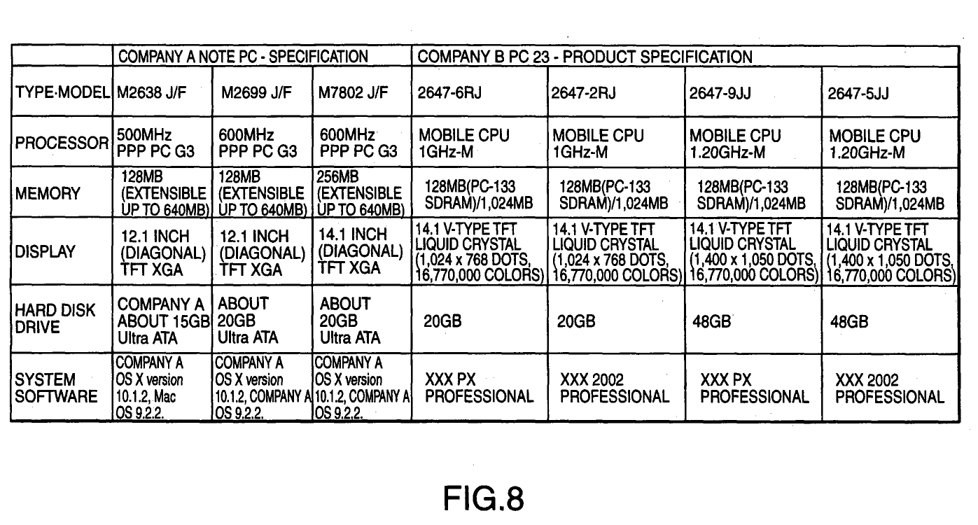

FIG. 8 is a diagram showing an example of a summing-up display in this embodiment. Here, commodity information in the home page shown in FIG. 6 and commodity information in the home page shown in FIG. 7 are put together, wherein, for example, “processor” shown in FIG. 6 and “CPU” shown in FIG. 7 are displayed by summing them up into an item designated as a “processor”. Specifically, using “ontology” representing a relationship between vocabularies, extraction is implemented with respect to tables that previously had no concept of meaning, by applying the technique described hereinbelow. Then, using ontologies with respect to columns of each table, an inference is implemented based on a superordinate/subordinate conceptual relationship, synonyms, antonyms, a logical operation and a predicate relationship to analogize meanings, thereby summing up the tables of the respective companies into one table. Namely, meanings are given to each table using ontologies, then the tables are extracted depending on the meanings, and those having the same meaning are summed up together. Through this processing, even if wording expressing a corresponding function differs per company, they are automatically judged to be the same thing based on the meaning given thereto, so that, for example, “CPU” and “processor” are summed up together judging that they represent the same thing. By referring to this summed-up table, a user can easily make a comparison using, for example, unified terms with respect to the information expressed differently by the respective companies.

An ontology, such as a notebook PC ontology, digital camera ontology or real estate ontology, can be defined per object domain, and thus it can be dynamically implemented through plug-ins. By applying an ontology operation to values of each table, it becomes possible to automatically convert from a language wherein, like a table described in HTML (Hypertext Markup Language), “A human being can understand meanings of the table which, however, is only display means to a machine, so that the machine can not understand a meaning of each column of the table”, into a format like XML (Extensible Markup Language) or RDF (Resource Description Framework) that can also be understood by the machine. As a specific application example, if the meanings can be given to each table as described above, it is possible, for example, to make a quantitative comparison using INS (Intelligent Notification Services) of a program product as to whether a user's interested-in event that has been registered in advance and a content of an existent Web page agree with each other, and thus, it is possible to configure a notification to a user when there is agreement with a user's interest.

Here, “ontology” is one method for expressing semantic information and is a set of sentences that define relationships between concepts and logical rules for interpreting them. For example, it is assumed that a content of “Sunday, the morning, Yamato, internal department” is searched. The words are taken as they are from HTML and output as a search result so that a lot of search ‘garbage’ has been generated. On the other hand, in “ontology”, logical rules are defined for interpreting (a) Yamato is a name of a city, (b) A hospital includes the internal department, the department of surgery and the department of otolaryngology, (c) There are consultation days and hours in a hospital, and so forth, and a search result can be obtained from a set of those sentences. As a result, it becomes possible to reduce the search garbage. In this embodiment, using this “ontology” with respect to the extracted tables, the processing relating to morphemics such as a swing of words is implemented by applying superordinate/subordinate conceptual relationship processing to vocabularies that differ and perform item matching. In this event, by providing “ontology” relative to various domains (e.g. insurance, stock, hospital, real estate, car, PC), it is possible to cope with various domains.

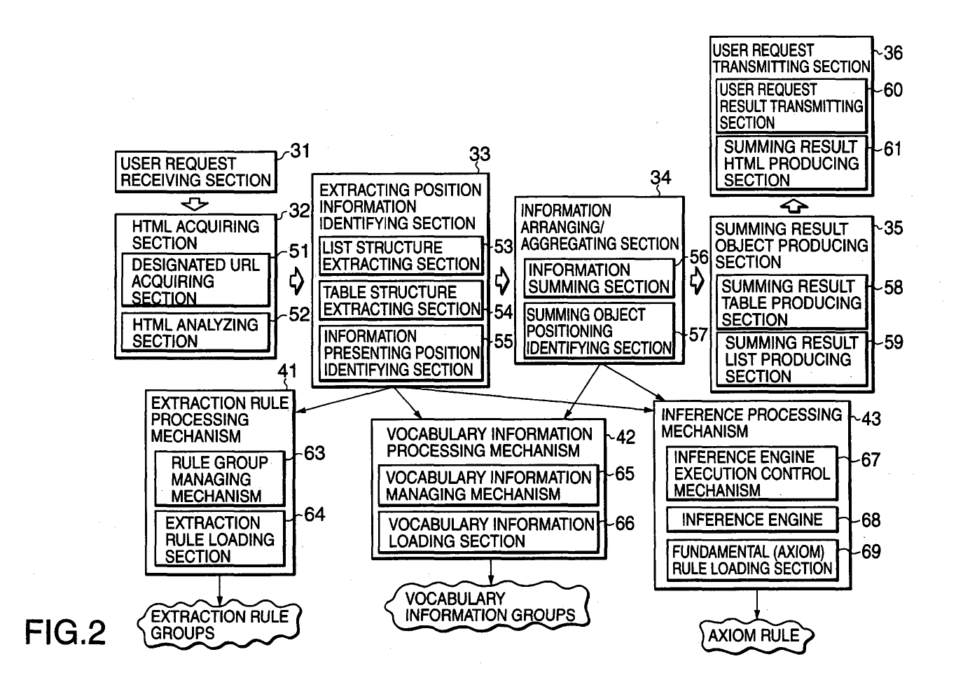

FIG. 2 is a block diagram showing a functional structure of the information distribution system 24 according to this embodiment, which is executed in the Web application server 20 shown in FIG. 1. In this embodiment, the information distribution system 24 comprises a user request receiving section 31 for receiving information about a user's interest, an HTML acquiring section 32 for acquiring an HTML document from a URL designated by the user request receiving section 31, an extracting position information identifying section 33 for paying attention to an HTML table and identifying a table (position) including data to be extracted, an information arranging/aggregating section 34 for summing up information acquired from a plurality of sites, a summing result object producing section 35 for converting the sum information (summed-up object obtained by the summing process) into a designated display format (summing result object) such as a table and displaying it, and a user request transmitting section 36 for offering the summing result to a user. The information distribution system 24 further comprises an extraction rule processing mechanism 41 for loading an associated extraction rule group based on a user concern expressing formula, a vocabulary information processing mechanism 42 for loading an associated ontology based on a user concern expressing formula, and an inference processing mechanism 43 for executing various inference operations when called from the extracting position information identifying section 33 or the information arranging/aggregating section 34.

First, the user request receiving section 31 receives a user concern expressing formula described, for example, in SQL (Structured Query Language), as a component suitably expressing a user's interest. In case of a notebook PC, this user concern expressing formula may be, for example, “Display a notebook having a price of $3,000 or less”. As another method, a specific keyword is input by a user, and a prescribed program identifies, from the keyword, a URL (Uniform Resource Locator) and an ontology type, which are handled as a user concern expressing formula. Specifically, after receiving an input of the text, a user concern expressing formula is produced by obtaining a promising object URL from a full text search engine. For example, the following URLs and ontology type can be obtained based on designation from the user and a search.

UserInterest

URL1 http://xxx.yyy

URL2 HYPERLINK “http://yyy.xxx” http://yyy.xxx

TargetSpec NotebookPCSpecOntology (DigitalCameraSpecOntology, RealEstateSpecOntology)

The HTML acquiring section 32 comprises a designated URL acquiring section 51 for acquiring the foregoing URL from the user request receiving section 31, and an HTML analyzing section 52 for analyzing an HTML portion from the acquired URL. As the acquired information position formula URL, it may be, for example, http://www.somecompany.com/products/notepc/newproduct.html. In the state where it is first acquired on the side of the Web application server 20, one page is entirely acquired as an HTML object (HTML syntax analyzing tree (tree structure)). Then, an HTML data structure analysis is conducted based on DOM (Document Object Model) so as to obtain tag information. Using, for example, API (Application Program Interface), the HTML analyzing section 52 extracts information about only a table portion from the HTML object, i.e. a table object (subset of HTML syntax analyzing tree). Similarly, it is also possible to extract a list using the same technique relative to a tree structure in list tags.

The extracting position information identifying section 33 calls out the extraction rule processing mechanism 41, the vocabulary information processing mechanism 42 and the inference processing mechanism 43 and extracts a data object. For this purpose, the extracting position information identifying section 33 comprises a list structure extracting section 53 for extracting a data object from a list structure such as <UL>, <OL> or <LI> in the HTML object acquired by the HTML acquiring section 32, a table structure extracting section 54 for extracting a data object from a table structure, and an information presenting position identifying section 55 for extracting, when a table tag is nested, a portion surrounded by inner table tags. Specifically, the HTML analyzing section 52 that conducts a syntax analysis of a list structure or a table structure makes objects into an extractable state, and the list structure extracting section 53 or the table structure extracting section 54 identifies a meaningful object and extracts it as an extraction data object. As an example of a portion to be extracted, for example, a portion surrounded by table tags like

TABLE 1

| | |
|---|---|
| Vocabulary: CPU | Value: Mobile CPU III |
| Vocabulary: HDD | Value: 20GB |
| : | : |

is extracted from the page of the catalog shown in FIG. 7, and a portion surrounded by table tags like

TABLE 2

| | |
|---|---|
| Vocabulary: processor | Value: PPP PC |
| Vocabulary: hard disk drive | Value: 15GB |
| : | : |

is extracted from the page of the catalog shown in FIG. 6, and are arrayed in a flat manner. On the other hand, upon conducting an analysis using a form tag as a clue, input data of a form is automatically inserted into an input tag of a form element based on preference in input of an interest or keyword from a user, a request is automatically submitted, and as a result, a table tag or list tag is extracted from HTML obtained as a response, thereby collecting information.

The extraction rule processing mechanism 41 comprises a rule group managing mechanism 63 for managing a rule group, and an extraction rule loading section 64 for loading an associated rule group from a prescribed memory, whereby an extraction rule group composed of extraction rules is prepared. In this extraction rule group, there are a plurality of rules such as:

There are many cases where all items become the same on the first line.

A vocabulary relating to a specification comes to the first column.

The first column (item column) and its corresponding column on the right have a certain relationship.

There are not more vacant cells than a certain degree.

1 kg representing the weight does not come to a column corresponding to a column of a CPU.

The extracting position information identifying section 33 refers to such a rule group and identifies extracting position information.

The vocabulary information processing mechanism 42 comprises a vocabulary information managing mechanism 65 for managing a vocabulary information group, and a vocabulary information loading section 66 for loading vocabulary information from a prescribed memory, whereby an ontology is loaded based on a user concern expressing formula (e.g. a desired (object) ontology is read from the ontology server 23 shown in FIG. 1) to obtain a vocabulary information group. As an example of the vocabulary information, the following ontology is used to compare personal computers of different companies:

Class CPU sameAs processor
Class processor sameAs CPU
Class cache memory
Class L2 cache subClassOf cache memory
Class weight subClassOf

unionOf body weight

battery weight

where “sameAs” represents “having the same meaning as”, “subClassOf” represents “relationship between superordination and subordination”, and “unionOf” represents “including”. For example, by defining a relationship that “weight” is “body weight”+“battery weight” using an ontology, it is possible to convert to information useful for a user.

As described above, the vocabulary information offered by the vocabulary information processing mechanism 42 includes relationships between vocabularies, and can include, for example, not only general relationships such as a superordinate/subordinate conceptual relationship, synonyms, antonyms and analogues, but also relationships peculiar to the vocabularies (physical relationship, time series relationship, system of units) and various relational definitions according to individual definitions by a vocabulary information definer. Further, such vocabulary information includes information forming the fundamental concept and information produced depending on a domain. The information produced depending on a domain may be based on the information forming the fundamental concept and refer to vocabulary information of other domains.

The inference processing mechanism 43 comprises an inference engine 68 for executing an inference operation, an inference engine execution control mechanism 67 for controlling execution of the inference engine 68, and a fundamental (axiom) rule loading section 69 for loading an axiom rule group from a prescribed memory, whereby the inference processing is implemented using axiom rules described in a rule describing format accepted by the inference engine 68. Here, the inference engine 68 is used to carry out semantic execution of an ontology and a driving rule is mounted. For example, a syllogism is carried out only from facts, wherein, for inferring from facts (metainformation described in ontology language) scattered on the Web, a categorical syllogism is mounted. As this categorical syllogism, there can be cited, for example,

(major premise) All men are mortal.

(minor premise) Socrates is a man.

(conclusion) Hence, Socrates is mortal.

A normal syllogism based on a logical language is expressed by a mixed hypothetical syllogism composed of a fact (categoricalness) and a conditional implication, i.e. if-then (hypothesis). In an example of the logical language, mortal(X):-man(X) (major premise) hypothesis (condition) man(socrates). (minor premise)categoricalness(fact) ?-mortal(socrates). →yes. (conclusion).

As mounting of a categorical syllogism, it becomes as follows in mounting of a transitive law.

/*TransitiveProperty*/
if pv(type, ?p, TransitiveProperty) and

pv(?p,?x,?y) and
pv(?p,?y,?z)

then

Pv(?p,?x,?z).

In this manner, in the inference processing mechanism 43, the axiom rule for deriving a new fact from facts using a syllogism by, for example, excluding disjointed ones and obtaining ones of the same value, is provided.

As described above, in the inference processing mechanism 43, for manipulating relationships in the vocabulary information defined by the vocabulary information processing mechanism 42 in the foregoing manner, the inference engine 68 is used so that logical operations in various relationships are mounted as rules. For example, through finding of a disjointed vocabulary, finding of an inclusion relationship, finding of a new fact by a syllogism, and so forth, the accuracy of extracting a table etc. forming a catalog or specification information is increased, and further, the same technique is applied upon comparing information extracted from a plurality of pages, thereby enabling automatic execution of pigeonholing and aggregating information. Incidentally, other than the categorical syllogism, axiom rules are also available for driving an inverse relationship, a disjointed relationship and so forth, respectively. In this embodiment, the inference processing is driven such that a relationship defined by an ontology is applied between itself and another relationship based on the fundamental axiom rules, thereby to infer a new fact, disjointing, etc.

The information arranging/aggregating section 34 comprises an information summing section 56 for performing a summing process, and a summing object positioning identifying section 57 for identifying positioning of summing objects, whereby a summed-up object is produced through a summing process from the extraction data objects extracted by the extracting position information identifying section 33. It is configured so that upon implementing the summing process, the vocabulary information processing mechanism 42 and the inference processing mechanism 43 are called and an ontology is associated with the respective vocabularies, thereby making it possible to aggregate the results thereof using an inference. In the summed-up object, giving association between vocabularies and values is performed transversely, an equivalent relationship is processed, and further, a new relationship is inserted. An example thereof may be a data structure like: Object

Object

Entry 1

Class:CPU OriginalVoc: CPU Value: Mobile CPU III
Class:HDD OriginalVoc: HDD Value: 20GB

| | | |
|---|---|---|
| : | : | : |

Entry 2

Class:CPU OriginalVoc: Processor Value: PPP PC
Class:HDD OriginalVoc: Hard Disk Drive Value:15GB

| | | |
|---|---|---|
| : | : | : |

Here, objects are produced such as “There is CPU as an original vocabulary of CPU” and “It was Processor as an original vocabulary in CPU”.

In this manner, in the information arranging/aggregating section 34, information pieces of, for example, notebook PCs acquired from two sites are summed up. For example, data like CPU of PC of company A is xxx and Processor of PC of company B is yyy is rearranged as data like Processor (i.e. CPU) of PC of company A is xxx and Processor (i.e. CPU) of PC of company B is yyy, in a position where information pieces of the latter can be arrayed as mutual comparison objects, and the latter is held as a summed-up object.

The summing result object producing section 35 comprises a summing result table producing section 58 and a summing result list producing section 59, whereby a summing result object is produced in the form of a table and/or a list with respect to the summed-up object obtained from the information arranging/aggregating section 34, for offering an easy-to-see summing result to a user.

The user request transmitting section 36 comprises a summing result HTML producing section 61 for producing a summing result HTML from the summing result object produced by the summing result object producing section 35, and a user request result transmitting section 60 for transmitting the produced HTML to the user whose request was received by the user request receiving section 31, whereby a comparison table as shown in FIG. 8 is offered to the user of the user terminal 11.

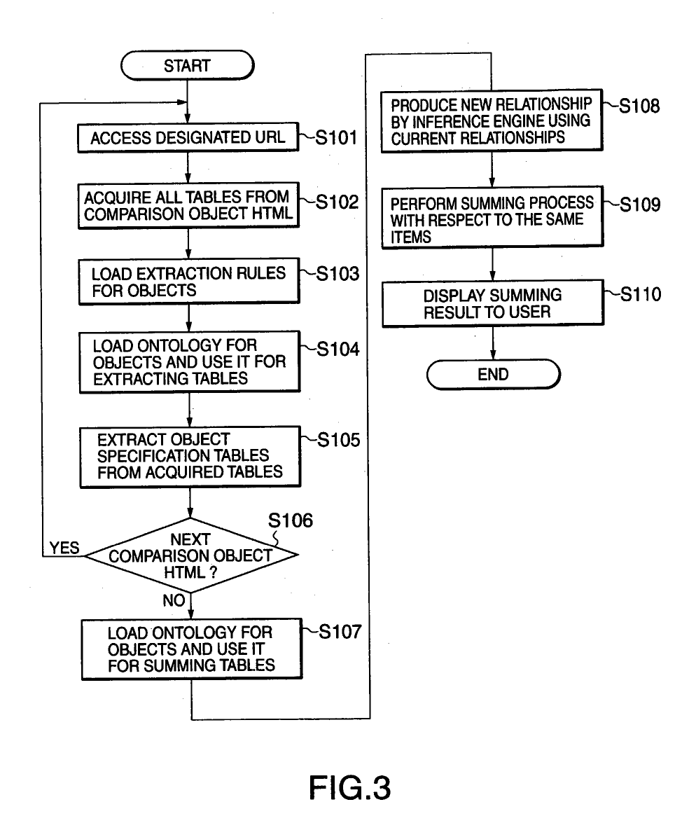

FIG. 3 is a flowchart showing the flow of the processing that is executed by the respective functions shown in the block diagram of FIG. 2, wherein the processing from the super ordinate concept is explained. First, the HTML acquiring section 32 accesses a URL designated by an information position formula from the user request receiving section 31 (step S101), and the extracting position information identifying section 33 acquires all tables from a comparison object HTML obtained from the HTML acquiring section 32 (step S102). In the extraction rule processing mechanism 41, extraction rules for objects are loaded (step S103). In the vocabulary information processing mechanism 42, an ontology for the objects is loaded and used for extracting the tables (step S104). In the extracting position information identifying section 33, using the extraction rules that have been loaded by the extraction rule processing mechanism 41, the ontology that has been loaded by the vocabulary information processing mechanism 42, and the axiom rules that are loaded by the inference processing mechanism 43, object specification tables are extracted from the acquired tables (step S105). Here, it is checked whether or not there is a next comparison object HTML (step S106). If positive at step S106, the processing returns to step S101. On the other hand, if negative at step S106, the ontology relative to the objects is loaded in the vocabulary information processing mechanism 42 and used for summing up the tables at step S109 (step S107). In the inference processing mechanism 43, a new relationship is produced by the inference engine 68 using the current relationships (step S108). Then, using the ontology loaded by the vocabulary information processing mechanism 42, the new relationship produced by the inference processing mechanism 43, and so forth, the information arranging/aggregating section 34 implements a summing process with respect to the same items, and the summing result object producing section 35 produces a summing result object (step S109). Thereafter, the user request transmitting section 36 displays a summing result to the user (step S110), and the whole processing is terminated.

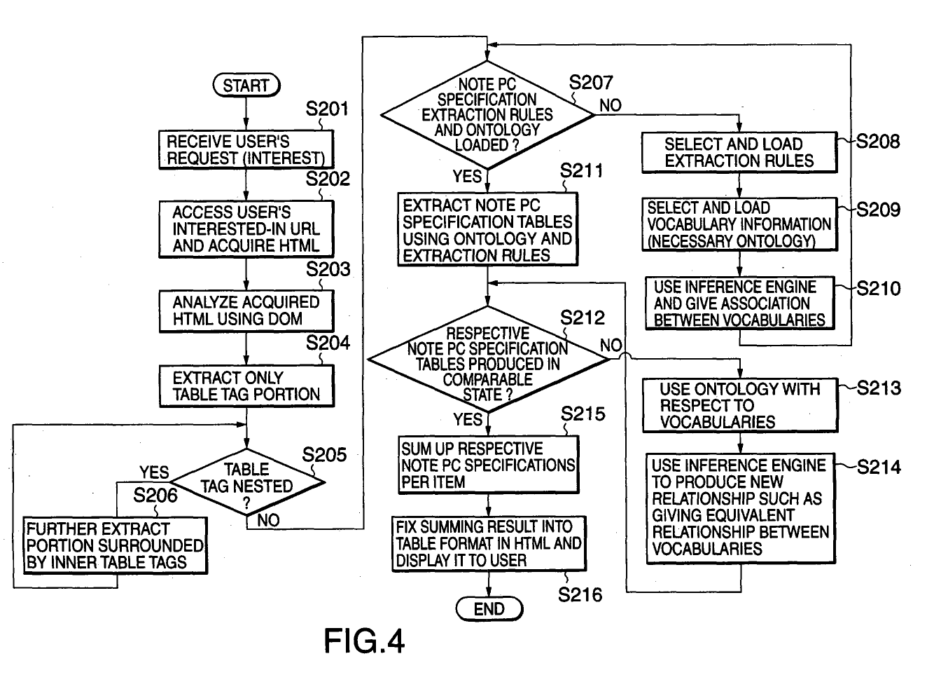

FIG. 4 is a flowchart describing the processing according to this embodiment in further detail. First, the user request receiving section 31 receives a user's request (interest)(step S201). Based on this received user's request, the HTML acquiring section 32 accesses a user's interested-in URL to acquire an HTML (step S202). In this event, it may be arranged that, for example, URLs each having a table are designated in advance. The extracting position information identifying section 33 analyzes the acquired HTML using DOM (step S203) and extracts only a table tag portion (step S204). Here, it is checked whether or not the table tag is nested (step S205). If positive at step S205, a portion surrounded by inner table tags is further extracted (step S206). While there still remains an inner table tag, steps S205 and S206 are repeated.

If the table tag is not nested at step S205, it is checked whether or not, for example, notebook pc specification extraction rules and a corresponding ontology are loaded by the extraction rule processing mechanism 41 and the vocabulary information processing mechanism 42 (step S207). If negative at step S207, the aforementioned extraction rules are selected and loaded in the extraction rule processing mechanism 41, so that, for example, a table corresponding to a portion relating to the notebook pc specification is extracted (step S208). On the other hand, the vocabulary information processing mechanism 42 selects and loads vocabulary information (necessary ontology, e.g. notebook pc ontology)(step S209). In the inference processing mechanism 43, the inference engine 68 is used and the driving rule is mounted so as to give association between vocabularies (step S210), and the processing returns to step S207. Here, for example, a syllogism is carries out from only facts like if “unionOf” comes, its sum is calculated. As described above, the ontology is selected and the selected ontology is used, so that, for example, using ontologies with respect to columns of each table, an inference is implemented based on a superordinate/subordinate conceptual relationship, synonyms, antonyms, a logical operation and a predicate relationship to analogize meanings, thereby summing up the tables of the respective companies into one table. When the inference engine 68 is applied to a notebook pc, the inference engine 68 is actually used and driven with respect to, for example, the fact (ontology) that “weight” is “body weight”+“battery weight”. For example, processing is executed that is “If there are a term of body and a term of battery, and there is information representing weight in those fields, those two are summed up to give a fact that labeling called weight is implemented”.

If notebook PC specification tables are produced at step S207, the extracting position information identifying section 33 extracts notebook pc specification tables using the ontology and the extraction rules (step S211). Internally, judgment is performed based on an evaluation function (e.g. to what extent the rule becomes true) on the basis thereof. After the extraction, the information arranging/aggregating section 34 checks whether or not the respective notebook pc specification tables are produced in a comparable state (step S212). For example, it is judged whether or not the tables are produced in the state where it can be judged whether or not there are the same items, or whether or not different wording is used with respect to seemingly the same items. If negative, access is made to the vocabulary information processing mechanism 42 to use the ontology with respect to vocabularies (step S213), or access is made to the inference processing mechanism 43 to use the inference engine 68 thereby to produce a new relationship such as giving an equivalent relationship between vocabularies (step S214), and the processing returns to step S212. If the tables are produced in the comparable state at step S212, the information arranging/aggregating section 34 sums up the respective notebook pc specifications per item, and the summing result object producing section 35 produces a table as a summing result (step S215). Thereafter, the user request transmitting section 36 fixes the summing result into a table format in HTML and displays it to the user terminal 11 (step S216), and the processing is terminated. As an uncomparable table upon table extraction at step S211, there can be cited a table in the state where respective field items are not normalized to the standard terms in case of summing-up with respect to, for example, notebook pcs. The standard terms are predetermined per use (per notebook pc in this example) by a vocabulary information group. For example, if a term of CPU is defined as a standard notebook pc specification in a vocabulary information group, a name of a field where a term of processor is used is changed into a field name of CPU through the processing at steps S213 and S214.

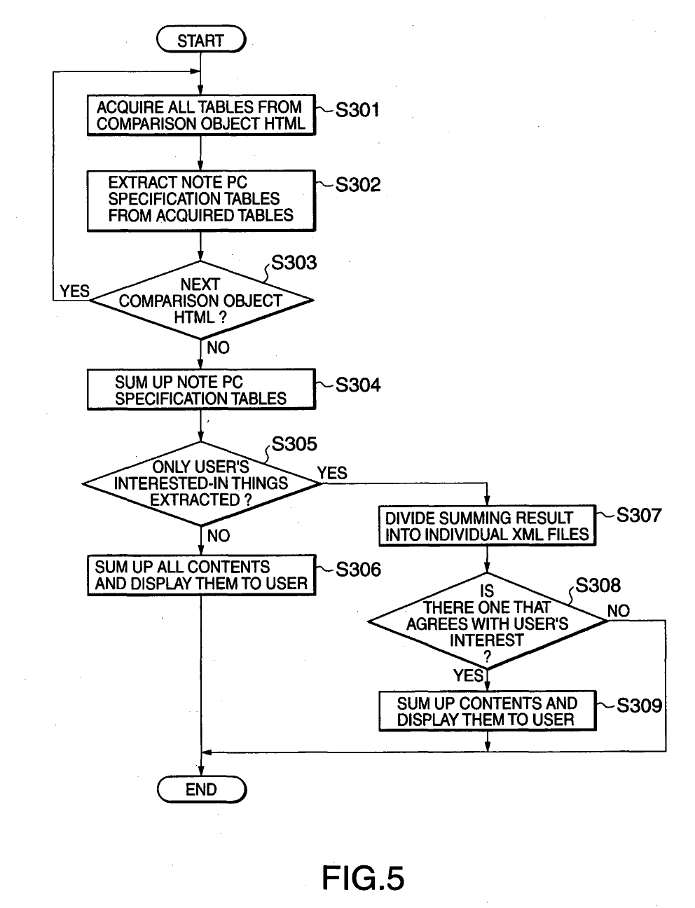

FIG. 5 is a flowchart describing displaying to the user terminal 11 in further detail. When URLs each having a table are designated beforehand in the user request receiving section 31, the HTML acquiring section 32 acquires all tables from a comparison object HTML (step S301). Then, the extracting position information identifying section 33 extracts notebook PC specification tables from the acquired tables (step S302) and checks whether there is a next comparison object HTML (step S303). If positive at step S303, the processing returns to step S301. On the other hand, if negative at step S303, the information arranging/aggregating section 34 sums up the notebook pc specification tables (step S304).

Thereafter, it is judged from a user concern expressing formula whether or not only user's interested-in things have been extracted (step S305). If negative at step S305, the information arranging/aggregating section 34 sums up all contents and displays them to the user (step S306), and the processing is terminated. “Extract only user's interested-in things” represents a process wherein if, for example, “Wishing to obtain information about notebook pcs having an HDD of 10 GB or more” is registered by a user in the form of a user concern expressing formula, after information about respective notebook pcs has been acquired from information sources, only those things that agree with the user's interest are extracted from such information. Unless only the user's interested-in things are extracted, all the acquired information is delivered to the user. On the other hand, if positive at step S305, the summing result is divided into individual XML files (step S307). Then, it is judged whether or not there is one that agrees with the user's interest (step S308). If negative at step S308, the processing is terminated as it is. If positive at step S308, the summing result object producing section 35 sums up the contents and displays them to the user (step S309), and the processing is terminated.

As described above, catalog or specification information is presented in a table or list format in many cases. However, according to the conventional technique, a table or list tag of HTML only designates a display format so that, for collecting and arranging information presented in a table or list format, it has been the only way to manually collect and arrange the information presented on a browser. Further, since headlines of information shown in a table format (headlines of information included in columns or lines) differ depending on information presenter (pages), it has been difficult to simply and mechanically arrange the information. Particularly, since a lot of table tags are used on a page as layout information, it has been difficult to extract necessary information simply from the table tags. In this embodiment, there is provided the function of identifying where the information is located, and a designated page is read in, so that user's designation is made possible with respect to category information to which page information belongs. Further, information extraction rules optimized to page are used, thereby to enable positioning of a table or list where the information exists. In the information extraction rules, positioning of information is implemented using positioning by HTML tags such as a table or list, and vocabulary information used on a page of each category.

In the table positioning, features constituting catalog or specification information, not layout information, are put into a rule, thereby to make it the first step of positioning. In the first step, it is judged whether or not column headlines and line headlines are generally used vocabularies as a category designated by a user in the tables where information extraction has been performed, whereby general vocabulary information is defined as a pattern and “swing” of vocabularies that differ per page is smoothed using the vocabulary information, so as to increase the accuracy of table identification. Further, by making exchangeable the table positioning depending on a using pattern in layout information of table or list tags based on a page category, and by exchanging vocabulary information relative to a column or line headline depending on a category, it is also possible to realize a general purpose mechanism that can cope with various categories. As described above, in this embodiment, it is possible to extract a plurality of necessary information pieces from a certain page, and pigeonhole information utilizing relationships between the plurality of information pieces.

As described above, in this embodiment, useful information is extracted from a nonstructural data file through an analysis using an ontology. Particularly, an analysis of a document described in HTML standardly used on the Internet is conducted using form and table tags, etc. as hints, thereby to perform information extraction. Further, using an ontology (relational description about terms), an analysis of the contents is transversely implemented even over a plurality of documents using differing terms, thereby enabling extraction of useful information. Further, using the result of the analysis, it is also possible to present the information to a user by reconstructing it in a more useful manner. Particularly, it can cope with various kinds of data files without adding a large change to a program, by applying it to summing-up of catalog-format information or by switching an ontology. Further, it is also possible to convert from HTML into a machine-processable language like XML.

Further, inasmuch as each Web page is not built up upon extracting information, dynamic loading is made possible by, for example, switching an ontology per object of extraction, like a notebook pc ontology, a digital camera ontology or a real estate ontology. Moreover, an extraction rule can be plugged in per object domain so that it is possible to cope with various domains by changing the plug-in. Specifically, since portions to be cores are all common, rebuilding is not necessary relative to each Web page so that the maintainability and productivity can be improved.

Further, the mean value, the total value and so forth can also be calculated. It is also possible to automatically convert from a language such as HTML having metainformation into a language such as XML added with metainformation. As application fields in this embodiment, there can be cited SI about Web sites, knowledge management, value addition to portal sites, and so forth. Moreover, the multiplier effect can also be expected with the Semantic Web that is the WWW in knowledge expression provided with the meaning grasping function.

As described above, according to this embodiment, it is possible to transversely analyze the contents with respect to a plurality of documents including different terms, so that information having the same meaning can be extracted. Similarly, it is also possible to acquire target information from a nonstructural document. Further, by summing up the analyzed results and producing a comparison table, it is possible to offer information to a user in a more useful manner. Moreover, by switching an ontology, it is possible to cope with various fields without adding a large change to a program.

As an application in this embodiment, there can be cited one wherein, for example, pamphlets/catalogs are electronically distributed to portable information terminals etc. in exhibitions etc., and similar items of the distributed pamphlets/catalogs are automatically summed up. By adding a function of converting or classifying the summed-up information into an expression format that facilitates comparison, and making it possible to display the conversion result or the classification result on the portable information terminals etc. or to print it, users can easily perform comparison/review utilizing the portable information terminals etc. instead of carrying a lot of pamphlets etc. upon visiting the exhibitions etc. Specifically, in the exhibitions etc., it becomes possible to extract the same items of electronic pamphlets or catalogs structured by XML etc. and given metadata by RDF, based on local or remote ontology information, thereby to offer table-format reports to users.

In another application relative to various real estate information, it is possible to extract tables on the Web, apply an ontology operation, and sum up a user's target from a plurality of real estate information sites and display them. With respect to information about cars, wherein information on the Web is diverse from different companies and thus necessary for each company to have its own database about information on other companies for performing comparison, it becomes possible, using the same method, to present the comparison result to users using the existing Web pages. It is also effective in other fields of interest such as shopping, tickets and auctions that are present on the Web, but can not be compared and summed up due to diverse handling by the respective companies. In this embodiment, attention has been paid to the HTML tables, but it can also be utilized even if they are replaced by forms. As described above, according to this embodiment, by applying ontologies to ad hoc and immature areas to provide the method having flexibility, it becomes possible to achieve reduction in labor for application development and to quickly apply ontologies and rules into modules and the plug-in, thereby making it possible to provide an information search system that is strong against change.

As described above, according to the present invention, it becomes possible to automatically extract information from various domains published on the Web.

What is claimed:

1. An information collection system comprising:
means for acquiring a plurality of data files via a network;
means for analyzing the plurality of data files acquired using a prescribed extraction rule and an ontology of relational description of terms; and
means for extracting necessary information from said plurality of data files based on results from said means for analyzing.

2. An information collection system according to claim 1, wherein said means for acquiring obtains documents described in Hypertext Markup Language using Uniform Resource Locators based on a user's interest, and
said means for analyzing analyzes said documents using specific tag information.

3. An information collection system according to claim 1, wherein said prescribed extraction rule used in the analysis by said means for analyzing is features constituting catalog and/or specification information that are put into a rule.

4. An information collection system according to claim 1, wherein said means for analyzing analyzes contents transversely using the ontology with respect to the plurality of data files using different terms.

5. An information collection system according to claim 1, further comprising offering means for reconstructing the information extracted by said extracting means, aggregating equivalent relationships from said information, and offering them to a user terminal.

6. An information collection system according to claim 1, further comprising ontology storing means for storing ontologies that differ per object, wherein said means for analyzing conducts an analysis by reading a prescribed ontology from said ontology storing means.

7. An application server comprising:
a user request receiving section for receiving information about a user's interest;
an HTML acquiring section for acquiring HTML documents from a plurality of sites based on said information received from said user request receiving section;
a vocabulary information processing mechanism for reading an ontology based on said information received from said user request receiving section to acquire vocabulary information; and
an extracting position information identifying section for obtaining extraction data objects with respect to said HTML documents acquired from said HTML acquiring section, relying on tags of said HTML documents and based on said vocabulary information offered from said vocabulary information processing mechanism.

8. An application server according to claim 7, further comprising an extraction rule processing mechanism that offers an extraction rule for applying extraction processing to said HTML documents acquired from said HTML acquiring section, wherein said extracting position information identifying section obtains the extraction data objects based on the extraction rule offered from said extraction rule processing mechanism.

9. An application server according to claim 7, further comprising an inference processing mechanism for executing an inference operation based on an axiom rule, wherein said extracting position information identifying section obtains the extraction data objects based on the inference operation executed by said inference processing mechanism.

10. An application server according to claim 7, further comprising:
an information arranging/aggregating section for applying a summing process to the plurality of extraction data objects obtained by said extracting position information identifying section;
a summing result object producing section for producing a table and/or a list based on a result of the summing process by said information arranging/aggregating section; and
a user request transmitting section for transmitting a summing result object produced by said summing result object producing section.

11. In a computer connected to a network, an information collection method comprising the steps of:
acquiring a plurality of data files via the network;
analyzing said plurality of acquired data files using a prescribed extraction rule and an ontology relational description of terms;
extracting useful information from said plurality of analyzed data files; and
reconstructing said extracted useful information in a manner useful to a user.

12. An information collection method according to claim 11, further comprising a step of extracting information from HTML documents acquired via the network based on table tags or list tags.

13. An information collection method according to claim 11, wherein said step of analyzing comprises a step of performing positioning of a table using said extraction rule that is obtained by putting features constituting catalog and/or specification information into a rule, and a step of smoothing a swing of vocabularies based on said ontology that defines vocabulary information representing whether or not a headline of the positioned table is a vocabulary that is generally used in a category designated by the user.

14. In a computer connected to the Internet, an information collection method comprising the steps of:
receiving information about a user's interest;
acquiring a plurality of documents via the Internet based on said user's interest;
selecting a specific ontology based on said user's interest from a plurality of stored ontologies; and
analyzing contents transversely with respect to said plurality of acquired documents using said selected specific ontology to extract useful information.

15. An information collection method according to claim 14, wherein said information about the user's interest is information relating to object URLs and an ontology type, and the step of acquiring said plurality of documents acquires HTML documents based on said object URLs and extracts table portions or list portions from said HTML documents.

16. In a computer connected to a network, an information collection method comprising:
acquiring a plurality of Web pages including information expressed by different vocabularies with respect to associated contents, respectively;
extracting information from said plurality of acquired Web pages based on table tags or list tags;
analyzing said extracted information transversely with respect to the different vocabularies of said plurality of Web pages based on an ontology representing relationships between vocabularies;
summing up the analyzed information; and
transmitting a summing result to a user terminal.

17. An information collection method according to claim 16, wherein said summing applies superordinate/subordinate conceptual processing and/or relational processing to the different vocabularies on the respective Web pages to implement matching of items.

18. A program product for causing a computer to have:
a function of acquiring a plurality of data files via a network;
a function of analyzing said plurality of acquired data files using a prescribed extraction rule and an ontology being relational description of terms;
a function of extracting useful information from said plurality of analyzed data files; and
a function of reconstructing said extracted useful information in a manner useful to a user.

19. A program product according to claim 18, wherein said function of analyzing executes an inference operation based on a prescribed axiom rule.

20. A program product according to claim 18, wherein said function of reconstructing processes an equivalent relationship with respect to associated vocabulary and value to insert a new relationship to reconstruct the information.

21. A program product for causing a computer to have:
a function of acquiring a plurality of documents via the Internet based on information about a user's interest;
a function of selecting a specific ontology based on said user's interest from a plurality of stored ontologies; and
a function of analyzing contents transversely with respect to said plurality of acquired documents using said selected specific ontology.

22. A program product for causing a computer to have:
a function of acquiring a plurality of Web pages including information expressed by different vocabularies with respect to associated contents, respectively;
a function of extracting information from said plurality of acquired Web pages based on table tags or list tags;
a function of analyzing said extracted information transversely with respect to the different vocabularies of said plurality of Web pages based on an ontology representing relationships between vocabularies; and
a function of summing up the analyzed information.
